(19) United States
(12) Patent Application Publication
(10) Pub. No.: US 2025/0242655 A1
(43) Pub. Date: Jul. 31, 2025

(54) AIR INTAKE DEVICE

(71) Applicants: Ningbo Geely Automobile Research & Development Co., Ltd., Ningbo (CN); Zhejiang Geely Holding Group Co., Ltd., Zhejiang (CN)

(72) Inventors: Patrik ANDREASSON, Ljunskile (SE); Anders KARLSSON, Västra Frölunda (SE); Henrik FRIBERG, Partille (SE); Johan LEVIN, Borås (SE)

(21) Appl. No.: 19/078,075

(22) Filed: Mar. 12, 2025

Related U.S. Application Data
(63) Continuation of application No. PCT/CN2023/120596, filed on Sep. 22, 2023.

(30) Foreign Application Priority Data
Sep. 28, 2022 (EP) 22198356

(51) Int. Cl. B60H 1/00

(52) U.S. Cl. CPC B60H 1/00028; B60H 1/00564; B60H 2001/00085

(57) ABSTRACT

An air intake device provides air to an air conditioning system of a vehicle and includes a collecting component with an air receiving opening, a duct arranged for transporting air from the collecting component to the air conditioning system, and a drainage container. The duct has a first duct part extending from the collecting component to a drainage container inlet, allowing air to flow from the collecting component into the drainage container, and a second duct part extending from a drainage container outlet to the air conditioning system, allowing air to flow from the drainage container to the air conditioning system. The inlet and outlet are arranged such that an airflow direction of the inlet and an airflow direction of the outlet form an angle α in the interval 90°≤α≤270° relative to each other, thereby redirecting an airflow in the drainage container.

### RELATED APPLICATION DATA

This application is a continuation of International Patent Application No. PCT/CN2023/120596, filed Sep. 22, 2023, and claims the benefit of European Patent Application No. 22198356.2, filed Sep. 28, 2022, the disclosures of which are incorporated herein by reference in their entireties.

### TECHNICAL FIELD

The invention relates to an air intake device and a vehicle.

### BACKGROUND

Today's HVAC (Heating Ventilation Air Conditioning) systems of vehicles require increased air volumes at the same time as the packing space available for arranging an air intake device is limited. The air quality has to be secured which means that no water is allowed to reach the HVAC system.

On one hand, any water, such as rainwater, in the air reaching the air intake device, has to be separated from the air before providing the air to the HVAC system, and on the other hand, any means for removing the water should not cause air pressure drops in the air intake device that will negatively affect the performance of the HVAC system.

### SUMMARY

An objective of the invention is to provide an air intake device for providing air to an air conditioning system of a vehicle, by which air intake device, water can be removed at the same time as the air pressure drop is kept to a minimum not adversely affecting the air conditioning system.

The objective is achieved by an air intake device for providing air to an air conditioning system of a vehicle, wherein the air intake device comprises a collecting component with an opening for receiving air, a duct arranged for transporting air from the collecting component to the air conditioning system, and a drainage container, wherein the duct has a first duct part extending from the collecting component to an inlet of the drainage container, allowing air to flow from the collecting component and into the drainage container, and a second duct part extending from an outlet of the drainage container to the air conditioning system, allowing air to flow out from the drainage container and to the air conditioning system, and wherein the inlet and the outlet are arranged such that an airflow direction of the inlet and an airflow direction of the outlet form an angle α in the interval 90°≤α≤270° relative to each other, thereby redirecting an airflow in the drainage container, wherein the angle α is defined such that for α=180° the airflow direction of the outlet is opposite to the airflow direction of the inlet.

The invention is based on the insight that by such an air intake device, water can be removed in an efficient way while minimizing the air pressure drop. Any water in the air flowing through the drainage container will be separated from the air in the drainage container. The drainage container preferably has a water drainage valve arranged in the bottom of the drainage container for removing the water collected in the drainage container.

According to one embodiment of the air intake device, the angle α is in the interval 140°<a<220°, preferably in the interval 160°<α<200°, and more preferably in the interval 170°<α<190°.

The airflow direction of the inlet and the airflow direction of the outlet are the main directions of the airflow directed into the drainage container and out from the drainage container, respectively.

According to a further embodiment, the airflow direction of the outlet is substantially opposite to the airflow direction of the inlet. In other words; a is substantially 180° and the air will be redirected 180° when passing through the drainage container. Hereby, any water of the air can be removed in a very efficient way.

According to a further embodiment, the outlet is arranged above the inlet. Hereby, the air is forced to flow upward before leaving the drainage container, and thereby, due to gravity, water is separated from the airflow.

According to a further embodiment, the air intake device has a pipe portion arranged at the outlet inside the drainage container, which pipe portion encloses the outlet, and preferably the pipe portion is an end portion of the second duct part, which end portion extends into the drainage container and ends inside the drainage container. Hereby, any water on the inside surface of the drainage container is prevented or counteracted from following the airflow out from the drainage container. Further, by using the end portion of the second duct part, no additional component has to be used.

According to a further embodiment, the inlet and the outlet are arranged on one and the same side of the drainage container. Hereby, the inlet and the outlet can be positioned close to each other which can be favourable when the packing space is limited, and the inlet and the outlet can be arranged such that an angle α=180° is achieved for redirecting the airflow correspondingly.

According to a further embodiment, the first duct part has at least one internal guiding vane arranged to counteract swirling of the air before entering the drainage container. Hereby, the airflow is more homogenous and less turbulent when reaching the drainage container which improves the separation of water from the air inside the drainage container.

According to a further embodiment, said at least one guiding vane extends in a longitudinal direction of the first duct part and divides the first duct part into a plurality of longitudinal air channels. Hereby, the air will be divided and transported in the air channels which reduces swirl tendency.

According to a further aspect, the invention relates to a vehicle comprising an air intake device as described herein. The advantages of the vehicle are substantially the same as the advantages already discussed hereinabove with reference to the different embodiments of the air intake device.

According to one embodiment of the vehicle, the air intake device comprises two of said duct arranged for transporting air from the collecting component to the air conditioning system, and two of said drainage container, wherein each drainage container is arranged at a respective side of the vehicle for drainage of water at a respective front wheel arch of the vehicle. Hereby, the performance of the air intake device can be improved at the same time as the packing space available can be utilized in good way.

Further advantages and advantageous features of the invention are disclosed in the following description and in the dependent claims.

### BRIEF DESCRIPTION OF THE DRAWINGS

With reference to the appended drawings, below follows a more detailed description of embodiments of the invention cited as examples.

In the drawings:

FIG. 1A is a schematic cut view of an air intake device,

FIG. 1B is a cross section view taken along B-B in FIG. 1A,

FIG. 2 shows a variant of the air intake device,

FIG. 3A is a perspective view of a further variant of the air intake device,

FIG. 3B is a cut view from below of the air intake device in FIG. 3A, and

FIG. 4 is a schematic view of a vehicle with the air intake device shown in FIG. 3A installed.

### DETAILED DESCRIPTION OF EXAMPLE EMBODIMENTS

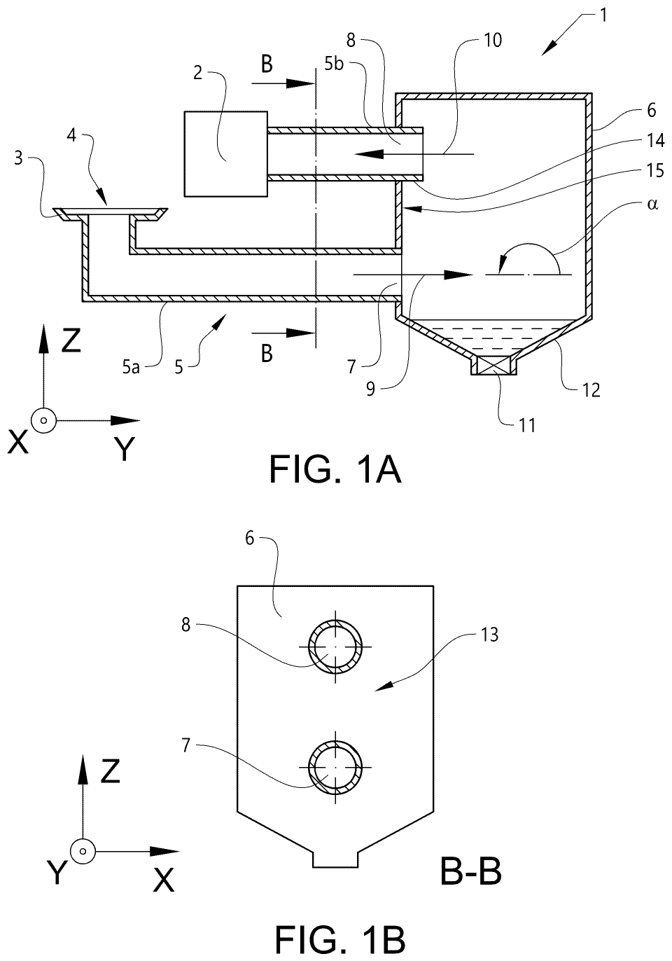

FIG. 1A is a cut view of an air intake device 1 for providing air to an air conditioning system or HVAC 2 (schematically indicated) of a vehicle. The air intake device 1 comprises a collecting component 3 with an opening 4 for receiving air, a duct 5 arranged for transporting air from the collecting component 3 to the air conditioning system 2, and a drainage container 6. The duct 5 is suitably closed, preferably along the entire extension from the collecting component 3 to the air conditioning system 2. The drainage container 6 is also closed against the surrounding.

Further, the duct 5 has a first duct part 5a extending from the collecting component 3 to an inlet 7 of the drainage container 6, which allows air to flow from the collecting component 3 and into the drainage container 6, and a second duct part 5b extending from an outlet 8 of the drainage container 6 to the air conditioning system 2, which allows air to flow out from the drainage container 6 and to the air conditioning system 2.

The inlet 7 and the outlet 8 are arranged such that an airflow direction 9 of the inlet 7 and an airflow direction 10 of the outlet 8 form an angle α in the interval 90°≤α≤270° relative to each other, thereby redirecting the airflow in the drainage container 6. The inlet airflow direction 9 and the outlet airflow direction 10 are the main directions of the airflow into and out from the drainage container 6, respectively.

In the example embodiment illustrated in FIG. 1A, the angle α is 180° between the airflow direction 9 of the inlet 7 and the airflow direction 10 of the outlet 8. In other words; the inlet 7 and the outlet 8 are arranged such that the airflow direction 10 of the outlet 8 is substantially opposite to the airflow direction 9 of the inlet 7.

Thus, the angle α is defined such that for α=180° the airflow direction of the outlet is opposite to the airflow direction of the inlet.

A cartesian coordinate system X, Y, Z, where all axes are orthogonal to each other, is introduced in FIG. 1A for facilitating the explanation of the air intake device 1.

In this example embodiment, the airflow direction 9 of the inlet 7 is in the positive Y-axis direction and the airflow direction 10 of the outlet 8 is in the negative Y-axis direction.

When the air intake device has its intended orientation, such as properly installed in a vehicle, the outlet 8 is arranged above the inlet 7, i.e. at a higher position on the vertical axis Z. Further, the drainage container 6 has a water drainage valve 11 arranged in the bottom 12 of the drainage container 6, and suitably the drainage valve 11 is arranged below the inlet 7, i.e. at a lower position on the vertical axis Z.

This means that the air will flow horizontally (to the right) into the drainage container 6 and be redirected 180° and then flow horizontally in the opposite direction (to the left) out of the drainage container. By arranging the outlet 8 above the inlet 7, the air is initially forced upwards during the redirection of the airflow.

The inlet 7 and the outlet 8 can be arranged on one and the same side 13 of the drainage container 6, and suitably at substantially same position along the X-axis. In FIG. 1B showing a cross section view taken along B-B in FIG. 1A, it is shown that the inlet 7 and the outlet 8 are arranged at one and the same side 13 of the drainage container 6 and at the same X-axis position.

The example embodiment of the air intake device 1 illustrated in FIG. 1A has a pipe portion 14 arranged at the outlet 8 inside the drainage container 6, which pipe portion 14 encloses the outlet 8, i.e. the pipe portion 14 extends circumferentially around the outlet. The pipe portion 14 projects from an inside surface 15 of the drainage container 6 into the drainage container 6 and constitutes a collar extending around the outlet opening.

The pipe portion 14 is suitably an end portion of the second duct part 5b or an extension thereof, which end portion extends into the drainage container 6 and ends inside the drainage container 6.

Optionally, the pipe portion 14 or collar arranged at the outlet 8 is a separate pipe portion attached to the inside surface 15. Such a pipe portion may have substantially the same dimensions as the outlet 8. For example, in case the outlet and the pipe portion both have circular cross sections, the inner diameter of the pipe portion can be equal to or somewhat greater than the diameter of the outlet opening.

In the same way as described with respect to the outlet 8 hereinabove, the air intake device 1 can have a pipe portion (not shown in FIG. 1A) arranged at the inlet 7 inside the drainage container 6, which pipe portion encloses the inlet 7, i.e. the pipe portion extends circumferentially around the inlet. The pipe portion can project from an inside surface 15 of the drainage container 6 into the drainage container 6 and constitute a collar extending around the inlet opening.

The pipe portion is suitably an end portion of the first duct part 5a or an extension thereof, which end portion extends into the drainage container 6 and ends inside the drainage container 6.

Optionally, the pipe portion or collar arranged at the inlet 7 is a separate pipe portion attached to the inside surface 15. Such a pipe portion may have substantially the same dimensions as the inlet 7. For example, in case the inlet and the pipe portion both have circular cross sections, the inner diameter of the pipe portion can be equal to or somewhat greater than the diameter of the inlet opening.

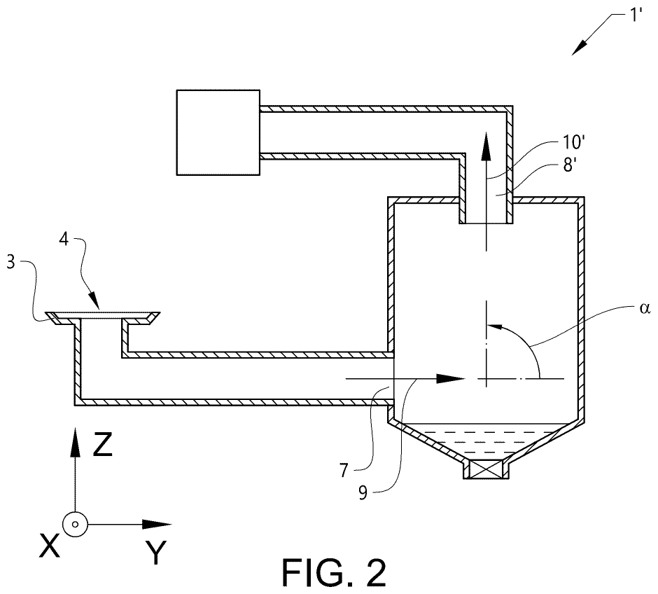

FIG. 2 shows a variant of the air intake device 1′ where the inlet 7 and the outlet 8′ are arranged such that the angle α formed between the airflow direction 9 of the inlet 7 and the airflow direction 10′ of the outlet 8′ is 90° for redirecting the airflow in the drainage container 6 correspondingly.

The airflow direction 9 of the inlet 7 is in the positive Y-axis direction and the airflow direction 10′ of the outlet 8′ is in the positive Z-axis direction.

This means that the air will flow horizontally (to the right) into the drainage container 6 and be redirected 90° and then flow vertically (upwards) out of the drainage container, and thus the air is forced upwards during the redirection of the airflow.

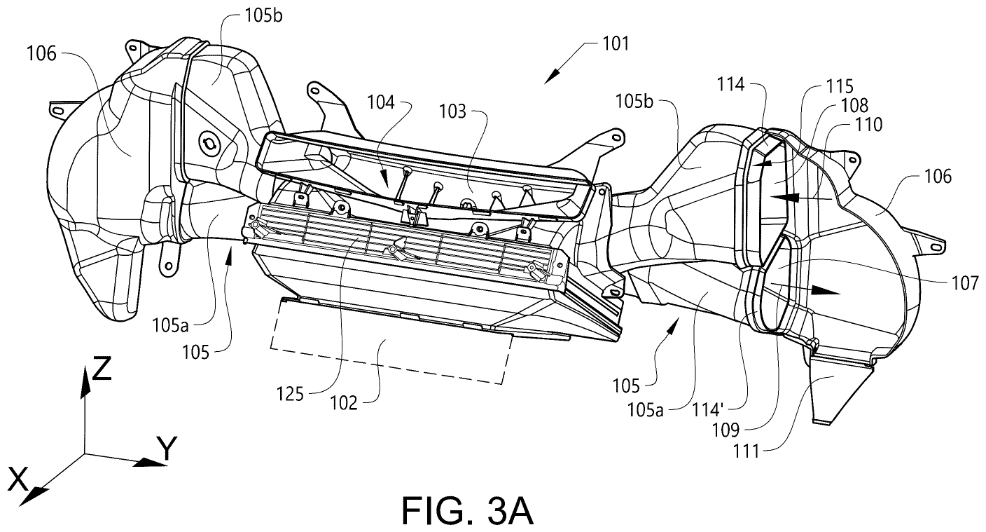

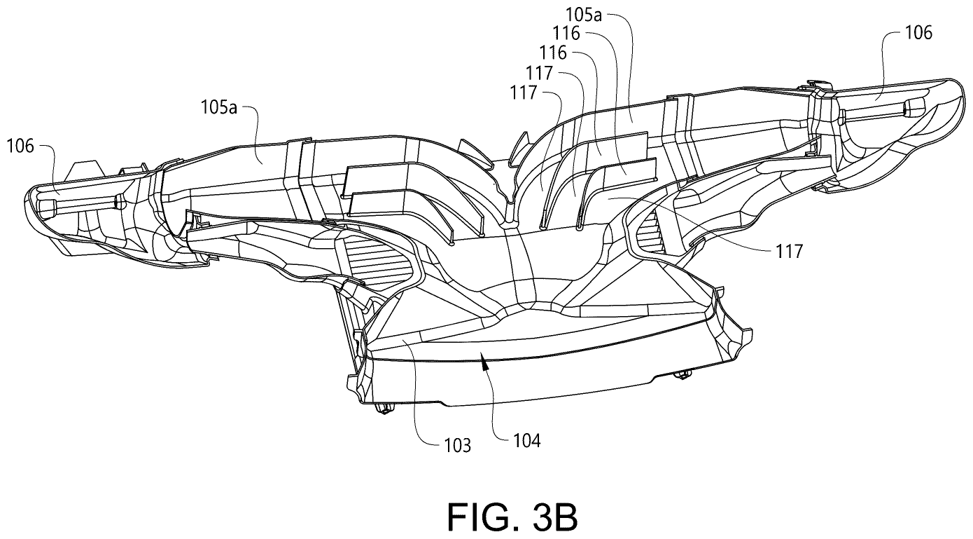

FIG. 3A shows a further variant of the air intake device 101 where the device comprises two of said duct 105 arranged for transporting air from the collecting component 103 to the air conditioning system or HVAC 102 (schematically indicated) and two of said drainage container 106. Further, an air filter 125 is suitably arranged downstream the drainage containers 106 and upstream the air conditioning system 102.

For each drainage container, the first duct part 105a extends from the collecting component 103 to the inlet 107 of the drainage container 106, which allows air to flow from the collecting component 103 and into the drainage container 106, and the second duct part 105b extends from the outlet 108 of the drainage container 106 to the air conditioning system 102, which allows air to flow out from the drainage container 106 and to the air conditioning system 102.

In the same way as explained with reference to the example embodiment illustrated in FIG. 1A, also in this example embodiment illustrated in FIG. 3A, the angle α is approximately 180° between the airflow direction 109 of the inlet 107 and the airflow direction 110 of the outlet 108. In other words; the inlet 107 and the outlet 108 are arranged such that the airflow direction 110 of the outlet 108 is substantially opposite to the airflow direction 109 of the inlet 107.

As appears from the partly cut view in FIG. 3A, the pipe portion 114 arranged at the outlet 108 inside the drainage container 106 encloses the outlet 108, i.e. the pipe portion 114 extends circumferentially around the outlet. The pipe portion 114 is the end portion of the second duct part 105b, which end portion extends into the drainage container 106 and ends inside the drainage container 106. The pipe portion 114 projects from the inside surface 115 into the drainage container 6 and constitutes a collar extending around the outlet opening.

As further appears from the partly cut view in FIG. 3A, the pipe portion 114′ arranged at the inlet 107 inside the drainage container 106 encloses the inlet 107, i.e. the pipe portion 114′ extends circumferentially around the inlet. The pipe portion 114′ is the end portion of the first duct part 105a, which end portion extends into the drainage container 106 and ends inside the drainage container 106. The pipe portion 114′ projects from the inside surface 115 into the drainage container 6 and constitutes a collar extending around the inlet opening.

FIG. 3B is a cut view from below of the air intake device 101 illustrated in FIG. 3A. FIG. 3B shows the inside of each first duct part 105a connecting the collector component 103 and the respective drainage container 106.

The first duct part 105a suitably has at least one internal guiding vane 116 arranged to counteract swirling of the air before entering the drainage container 106. Preferably, said at least one guiding vane 116 extends in a longitudinal direction of the first duct part 105a and divides the first duct part 105a into a plurality of longitudinal air channels 117. In the example embodiment illustrated in FIGS. 3A and 3B, each first duct part 105a has two guiding vanes 116 providing three air channels 117. The guiding vanes 116 can also be used for initially dividing the main airflow reaching the collector component 103 into a first sub airflow directed to one of the drainage containers and second sub airflow directed to the other of the drainage containers.

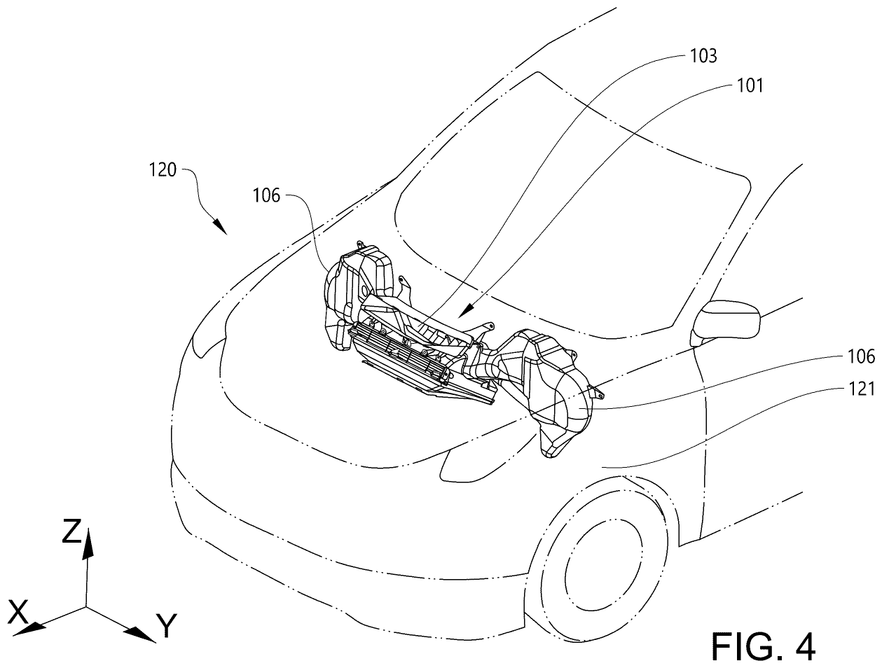

FIG. 4 shows a vehicle 120 comprising an air intake device 101. For example, the air intake device 101 can be the same as illustrated in FIG. 3A, where each drainage container 106 is arranged at a respective side of the vehicle 120 for drainage of water at a respective front wheel arch 121 of the vehicle 120.

When the air intake device 101 is arranged in a vehicle 120, the directions and axes used in the cartesian coordinate system, i.e. the X-axis, Y-axis and the Z-axis, are arranged relative to the vehicle 120 such that the X-axis is a horizontal axis in parallel with the longitudinal extension direction or normal driving direction of the vehicle 120, the Y-axis is a horizontal axis in parallel with the lateral extension of the vehicle 120, and the Z-axis is a vertical axis.

It is to be understood that the present invention is not limited to the embodiments described above and illustrated in the drawings; rather, the skilled person will recognize that many changes and modifications may be made within the scope of the appended claims.

What is claimed is:

1. An air intake device for providing air to an air conditioning system of a vehicle, the air intake device comprising a collecting component with an opening for receiving air, a duct arranged for transporting air from the collecting component to the air conditioning system, and a drainage container, wherein the duct has a first duct part extending from the collecting component to an inlet of the drainage container, allowing air to flow from the collecting component and into the drainage container, and a second duct part extending from an outlet of the drainage container to the air conditioning system, allowing air to flow out from the drainage container and to the air conditioning system, wherein the inlet and the outlet are arranged such that an airflow direction of the inlet and an airflow direction of the outlet form an angle α in the interval 90°≤α≤2700 relative to each other thereby redirecting an airflow in the drainage container, wherein the angle α is defined such that for α=180° the airflow direction of the outlet is opposite to the airflow direction of the inlet.

2. The air intake device according to claim 1, wherein the angle α is in the interval 140°<α<220°.

3. The air intake device according to claim 1, wherein the angle α is in the interval 160°<α<200°.

4. The air intake device according to claim 1, wherein the angle α is in the interval 170°<α<190°.

5. The air intake device according to claim 1, wherein the angle α is substantially 180° and thereby the airflow direction of the outlet is substantially opposite to the airflow direction of the inlet.

6. The air intake device according to claim 1, wherein the outlet is arranged above the inlet.

7. The air intake device according to claim 1, wherein the air intake device has a pipe portion arranged at the outlet inside the drainage container, which pipe portion encloses the outlet.

8. The air intake device according to claim 7, wherein the pipe portion is an end portion of the second duct part, which end portion extends into the drainage container and ends inside the drainage container.

9. The air intake device according to claim 1, wherein the inlet and the outlet are arranged on one and the same side of the drainage container.

10. The air intake device according to claim 1, wherein the drainage container has a water drainage valve arranged in the bottom of the drainage container.

11. The air intake device according to claim 1, wherein the first duct part has at least one internal guiding vane arranged to counteract swirling of the air before entering the drainage container.

12. The air intake device according to claim 11, wherein at least one guiding vane extends in a longitudinal direction of the first duct part and divides the first duct part into a plurality of longitudinal air channels.

13. The air intake device according to claim 1, wherein the air intake device comprises two of said duct arranged for transporting air from the collecting component to the air conditioning system, and two of said drainage container.

14. A vehicle comprising the air intake device according to claim 1.

15. The vehicle according to claim 14, the air intake device comprising two of said duct arranged for transporting air from the collecting component to the air conditioning system, and two of said drainage container, wherein each drainage container is arranged at a respective side of the vehicle for drainage of water at a respective front wheel arch of the vehicle.
